(19) United States
(12) Patent Application Publication
(10) Pub. No.: US 2024/0394765 A1
(43) Pub. Date: Nov. 28, 2024

(54) Pay-It-Forward in Theaters and Other Venues

(71) Applicant: Angel Studios, Inc., Provo, UT (US)

(72) Inventors: Jeffrey Harmon, Provo, UT (US); Neal Harmon, Provo, UT (US)

(21) Appl. No.: 18/622,858

(22) Filed: Mar. 29, 2024

Related U.S. Application Data
(60) Provisional application No. 63/455,418, filed on Mar. 29, 2023.

(51) Int. Cl. G06Q 30/0601; G06K 19/06

(52) U.S. Cl. CPC G06Q 30/0601; G06K 19/06037

(57) ABSTRACT

A movie engagement system may comprise presenting a pay-it-forward prompt to a movie theater patron in conjunction with showing the credits for a movie.

### CROSS-REFERENCE TO RELATED APPLICATIONS

This application claims priority to U.S. provisional application No. 63/455,418, titled “PAY-IT-FORWARD IN THEATERS AND OTHER VENUES,” the first inventor of which is Neal Harmon, which was filed on Mar. 29, 2023, and which is incorporated herein by reference in its entirety.

### BACKGROUND OF THE INVENTION

Engaging with patrons in a movie theater or other performance setting may be difficult because movie theaters have traditionally been a one-way communication experience for patrons: the movie theater communicates to patrons by showing movies, advertisements, and other content. What is needed is an improved approach for interacting with and engaging patrons in movie theaters and other performance settings.

### BRIEF SUMMARY OF THE INVENTION

### Brief Description of the Drawings

FIG. 1 shows an exemplary interface for engaging patrons.

FIG. 2 shows an exemplary interface for engaging patrons that includes a live feed.

FIG. 3 shows a flowchart for an exemplary method as described herein.

FIG. 4 shows a flowchart for an exemplary method as described herein.

### DETAILED DESCRIPTION OF THE INVENTION

In the disclosure herein, “consuming” content is used to generally describe ways that a person may consume audiovisual or other media content. Consumption often comprises watching and listening, but consumption could also comprise watching without sound, listening without visual, or any other mode of perceiving media content.

In general, a pay-it-forward donation is a payment (in money or possibly other currency, e.g., cryptocurrency, etc.) made by a first user toward a second user's future (relative to the time of the payment/contribution/donation) consumption of content. In some embodiments “pay-it-forward” may be broadly construed to include a first user's payment toward a second user's consumption of content regardless of the timing of the second party's consumption of content relative to the time at which the pay-it-forward payment was made. In general, the term “pay-it-forward” refers to a first user paying for something for a second user, often for something the second user will consume in the future.

The cost of creating and distributing content may be paid, tracked, and/or accounted for in whole or in part under a pay-it-forward paradigm. In a pay-it-forward paradigm the content may be provided to some or all users (“beneficiary user(s)”) for no cost, and the actual cost of creating and distributing may be borne in whole or in part by a benefactor user(s). For example, a benefactor user may be another user who has consumed the content and has determined to pay it forward by making a donation/payment for one or more others (beneficiary users) to consume the content.

In one embodiment, a content producer/distributor may determine that the cost of creating and distributing content is $1.00 per view. Any benefactor user or other benefactor who makes a pay-it-forward payment/donation may be understood to be financing consumption of the content for the number of beneficiary users that is the result of dividing the amount donated by $1.00. For example, donating $150 would fund 150 views (e.g., streaming) of the content. Many variants on this scheme could be implemented. For example, a user/benefactor could partially fund other views, e.g., at 50%, so that a donation of $150 would pay to subsidize 50% of 300 views.

### Theater/Live Event

A pay-it-forward scheme may be implemented at or in conjunction with a live event, e.g., a movie shown in a theater. For example, in conjunction with the conclusion of a movie or other presentation in a theater, a pay-it-forward prompt (visual, audio, or otherwise) may be presented to viewers/consumers to solicit or prompt a pay-it-forward donation or similar donation/contribution. “In conjunction with the conclusion of a movie” may be during the credits, during the closing scene, after the credits. The prompt may be shown with the credits, next to the credits, overlaid over the credits, on a separate screen and/or viewing surface/area in the theater, or in any other manner that will be perceptible to viewers/consumers that are present in the theater (or other venue or viewing and/or consumption of content or performances). The pay-it-forward prompt is not necessarily presented in conjunction with the conclusion of the movie/content, but may also or alternatively be presented at some other time in conjunction with presentation of the principal content.

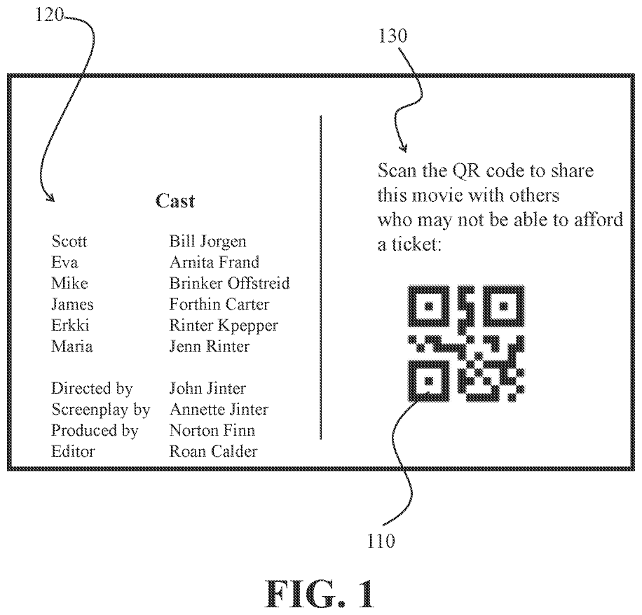

In one embodiment, as shown in FIG. 1, a QR code 110 may be shown during the credits 120 with a prompt 130 such as, “Pay it Forward for others who may not be able to afford a ticket to this movie. Scan QR code to pay it forward by purchasing ticket(s) for others.” When a viewer/consumer uses their smart phone or other device to follow the link encoded in the QR code, the user is taken to an online interface (e.g., website, app that user may already have on their phone/device, prompt to install app on phone/device) to present to the viewer an opportunity to purchase one or more event (e.g., movie) tickets for another. For example, the interface may present to the user information such as “$10.00/ticket allows others in your area to see this movie” and may also provide an e-commerce interface to allow the user to select an amount of money to contribute and/or to select a number of tickets to purchase for others.

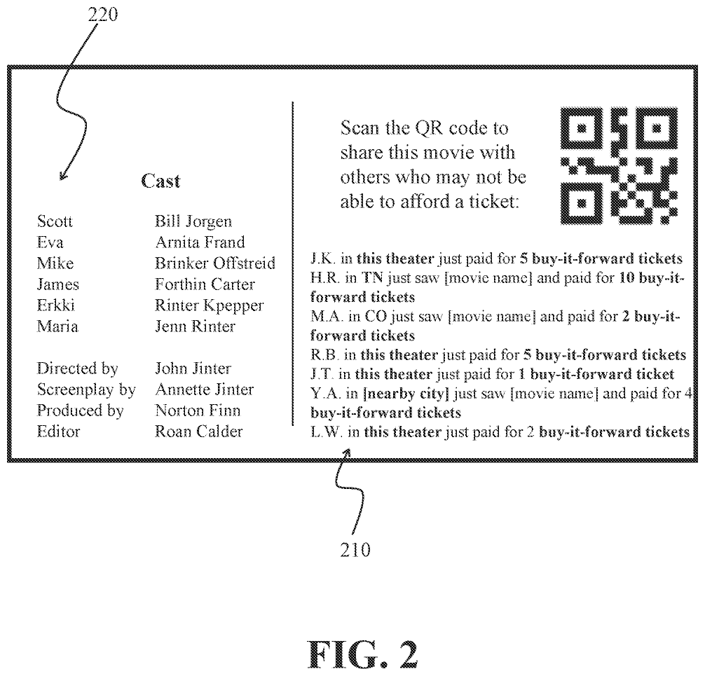

In one embodiment, as shown in FIG. 2, a live feed 210 of pay-it-forward tickets purchased in that theater may be presented during the credits 220 and/or otherwise in conjunction with the pay-it-forward prompt. The live feed may show transactions that have been finalized, or are in progress, or that are being explored. The live feed may additionally or alternatively be presented through a viewer's smartphone or other device, e.g., through an Internet browser or app. As presented in a viewer's smartphone or other electronic device, the live feed could be presented in conjunction with an interface for purchasing pay-it-forward tickets.

The live feed may be customized based on geography/location, demographics, or other filters/factors.

In one embodiment, a separate projector and/or screen may be used to provide the pay-it-forward prompt.

In one embodiment, a theater/distributor (or other interested party) may have access to a viewer's phone by having the viewer's phone number (for texting), email address, and/or an app installed on the viewer's phone, and may send a pay-it-forward prompt (e.g., text message, email, phone notification, notification through other social media, etc.) that is timed to arrive in conjunction with the credits or end of the movie (or other content/performance), or otherwise at a time at which it has been determined to provide a notification/communication regarding a pay-it-forward prompt. For example, the local theater may have a phone app to sell movies, sell concessions, and send users discount codes for movie and concession purchases. Many of these apps will use the viewer's location to send notifications such as “Please silence your phones” or “Today's Special!” Using the viewer's location and/or current time a notification will display on the viewer's phone prompting “Loved the movie? Pay it forward now.”

### Exemplary Method

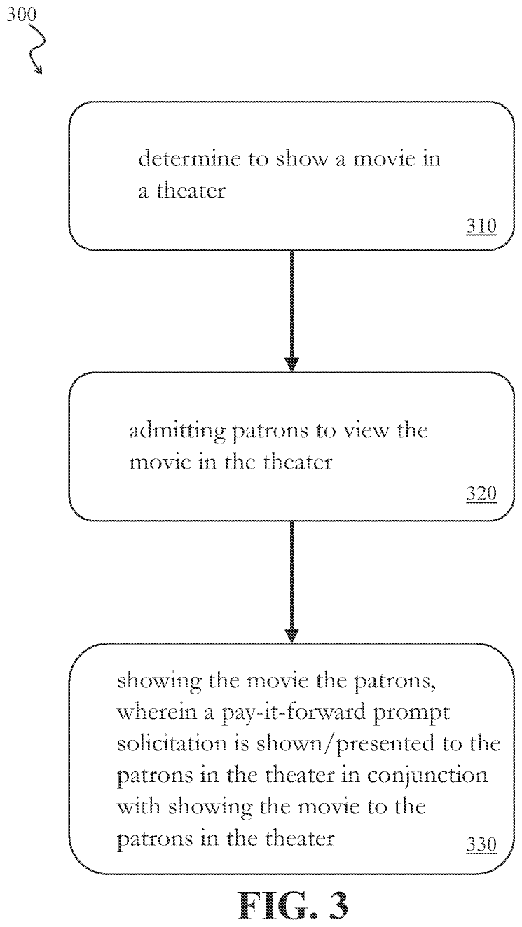

As shown in FIG. 3, and exemplary method 300 may comprise: at step 310, determining to show a movie in a theater; at step 320, admitting patrons to view the movie in the theater; and at step 330, showing the movie the patrons, wherein a pay-it-forward prompt solicitation is shown/presented to the patrons in the theater in conjunction with showing the movie to the patrons in the theater.

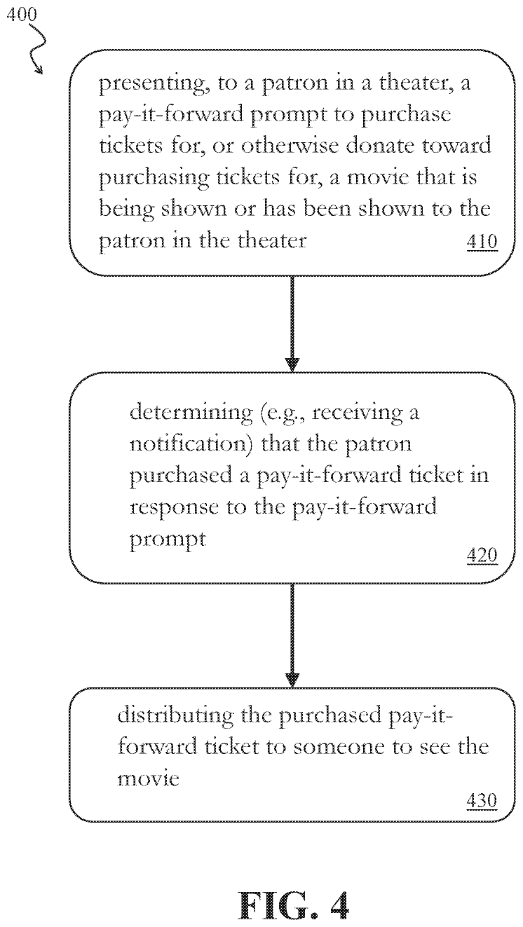

As shown in FIG. 4, another exemplary 400 method may comprise: at step 410, presenting, to a patron in a theater, a pay-it-forward prompt to purchase tickets for, or otherwise donate toward purchasing tickets for, a movie that is being shown or has been shown to the patron in the theater; at step 420, determining (e.g., receiving a notification) that the patron purchased a pay-it-forward ticket in response to the pay-it-forward prompt; and at step 430, distributing the purchased pay-it-forward ticket to someone to see the movie. An optional step may be presenting information to other patrons about the pay-it-forward ticket purchased by the patron.

What is claimed is:

1. A method, comprising:
presenting media content to at least one patron in person at a live performance;
presenting an engagement prompt to the at least one live patron in conjunction with presenting media content at the live performance.

2. The method of claim 1, wherein the media content is a movie and the live performance is showing the movie at a movie theater.

3. The method of claim 1, wherein the engagement prompt is a pay-it-forward prompt.

4. The method of claim 2, wherein the engagement prompt is a pay-it-forward prompt.

5. The method of claim 3, wherein the pay-it-forward prompt comprises a QR code on a movie screen.

6. The method of claim 3, wherein the pay-it-forward prompt comprises a QR code on a movie screen.

7. The method of claim 4, wherein the pay-it-forward prompt is presented during credits for the movie.

8. The method of claim 6, wherein the pay-it-forward prompt is presented during credits for the movie.

9. The method of claim 8, wherein the QR code is shown adjacent to the credits for the movie.

10. The method of claim 4, further comprising presenting, in conjunction with the pay-it-forward prompt, a live feed comprising other pending or completed pay-it-forward transactions for the movie.

11. The method of claim 10, wherein the live feed is filtered based at least in part on geography.

12. The method of claim 10, wherein the live feed is filtered based at least in part on both geography and time.

13. The method of claim 4, wherein the pay-it-forward prompt is presented through a smart phone.
